(19) United States
(12) Patent Application Publication
(10) Pub. No.: US 2011/0267267 A1
(43) Pub. Date: Nov. 3, 2011

(54) INFORMATION PROCESSING APPARATUS, INFORMATION PROCESSING METHOD, AND PROGRAM THEREFOR

(75) Inventors: Yutaka Hasegawa, Kanagawa (JP); Shigeatsu Yoshioka, Kanagawa (JP); Masashi Kimoto, Tokyo (JP); Masao Kondo, Tokyo (JP)

(73) Assignee: SONY CORPORATION, Tokyo (JP)

(21) Appl. No.: 13/084,797

(22) Filed: Apr. 12, 2011

(30) Foreign Application Priority Data
Apr. 16, 2010 (JP) P2010-095532

(51) Int. Cl. G06F 3/038

(52) U.S. Cl. 345/157

(57) ABSTRACT

An information processing apparatus includes: a connection unit to connect a first and second input apparatuses, the first input apparatus measuring a movement direction and a movement amount in a two-dimensional space, moving a pointer on a screen corresponding to the two-dimensional space based on a measurement result, and selecting a position on the screen, the second input apparatus measuring a movement direction and a movement amount in the two-dimensional space, moving a selectable position on the screen corresponding to the two-dimensional space based on a measurement result, and selecting a position on the screen; an input apparatus switching unit to select an input apparatus to be used by switching between the first and second input apparatuses; and an object display unit to display objects on the screen and select a display mode of the objects by switching between a first and second display modes.

### CROSS REFERENCES TO RELATED APPLICATIONS

The present application claims priority to Japanese Priority Patent Application JP 2010-095532 filed in the Japan Patent Office on Apr. 16, 2010, the entire content of which is hereby incorporated by reference.

### BACKGROUND

The present application relates to an information processing apparatus, an information processing method, and a program therefor that are capable of controlling a UI (User Interface) displayed on a screen.

In a field of medicine, pathology, or the like, there has been proposed a system that digitizes an image of a cell, a tissue, an organ, or the like of a living body, which is obtained by an optical microscope, to examine the tissue or the like or diagnose a patient by a doctor or a pathologist based on the digitized image (see Japanese Patent Application Laid-open No. 2009-37250). In such a system, a pathologist uses an input apparatus such as a mouse or a game controller to operate a UI displayed on a screen, thus observing an image of a cell or the like (hereinafter, referred to as pathological image). In order that a pathologist observes a pathological image efficiently or with high accuracy, the high operability of UIs is desired.

Japanese Patent Application Laid-open No. 2000-89892 (see, for example, [0034] to [0036], FIG. 5, etc.) discloses a display control method capable of switching between whether to handle an operation of an arrow key of a remote controller used by a user as a mouse cursor or an anchor cursor by an area (window) on a screen. By the display control method, UIs having high operability are realized.

### SUMMARY

For example, when a pathologist observes a pathological image, various operations such as an operation of scrolling the pathological image and an operation of selecting another pathological image are necessary in many cases. Therefore, there may be a case where each pathologist uses a different input apparatus. Specifically, a pathologist uses a pointing device such as a mouse, and another pathologist uses a game controller or the like. However, generally, it is difficult to operate a UI suitable for a mouse by using a game controller, and vice versa. Therefore, there may be a case where a pathologist is incapable of efficiently observing an image displayed on a screen depending on the type of input apparatus to be used.

In view of the circumstances as described above, it is desirable to provide an information processing apparatus, an information processing method, and a program therefor that enable a user to efficiently observe an image displayed on a screen irrespective of a type of input apparatus used by a user.

According to an embodiment, there is provided an information processing apparatus including a connection unit, an input apparatus switching unit, and an object display unit.

The connection unit connects a first input apparatus and a second input apparatus, the first input apparatus being capable of measuring a movement direction and a movement amount in a two-dimensional space, moving a pointer on a screen corresponding to the two-dimensional space based on a measurement result, and selecting a position on the screen, the second input apparatus being capable of measuring a movement direction and a movement amount in the two-dimensional space, moving a selectable position on the screen corresponding to the two-dimensional space based on a measurement result, and selecting a position on the screen.

The input apparatus switching unit selects an input apparatus to be used by switching between the first input apparatus and the second input apparatus.

The object display unit displays a plurality of objects on the screen and selects a display mode of the plurality of objects on the screen by switching between a first display mode corresponding to the first input apparatus and a second display mode corresponding to the second input apparatus, the first display mode being selected when the first input apparatus is used, the second display mode being selected when the second input apparatus is used.

In the information processing apparatus, the first input apparatus and the second input apparatus having different types are connected to the connection unit. Then, between when the first input apparatus is used and when the second input apparatus is used, the display modes of the plurality of objects displayed on the screen are switched. In other words, when the first and second input apparatuses are used, UIs displayed on the screen are switched. With this structure, a user can efficiently observe an image displayed on a screen irrespective of whether an input apparatus to be used is the first input apparatus or the second input apparatus.

When the first input apparatus is used, the object display unit may arrange the plurality of objects on the screen, set one of the plurality of objects displayed in a selectable state, and set, as the first display mode, a display mode in which the object in the selectable state is changed by moving the pointer in conjunction with an operation of the first input apparatus. Further, when the second input apparatus is used, the object display unit may arrange the plurality of objects on the screen, set one of the plurality of objects, which corresponds to a predetermined position on the screen, in a selectable state, and set, as the second display mode, a display mode in which the object in the selectable state is changed by moving the plurality of objects in conjunction with an operation of the second input apparatus.

As described above, the UI displayed on the screen is different between the first and second display modes, and an operation method for the UI is also different therebetween. Accordingly, for example, a user can select an input apparatus to be used as appropriate and observe an image in a display mode that is easy for the user to operate. Further, for example, even in the case where the first and second input apparatuses are mixed as input apparatuses to be used, such as a case where a plurality of users observe an image, the plurality of users efficiently observe an image.

The second display mode may be a display mode in which the object set in the selectable state is displayed with emphasis. Accordingly, a user who uses the second input apparatus can efficiently operate a UI displayed on the screen.

The information processing apparatus may further include a storage configured to store a plurality of image data items each having a first resolution. In this case, each of the plurality of objects may be an image obtained by drawing one of the plurality of image data items stored in the storage in a second resolution smaller than the first resolution.

The object display unit may set a first area and a second area on the screen, display a plurality of images each having the second resolution in the first area, as the plurality of objects, and display, in the second area, an image having the first resolution that corresponds to one of the plurality of objects selected in the first area by one of the first input apparatus and the second input apparatus. Further, in a case where the input apparatus to be used is switched to the second input apparatus by the input apparatus switching unit when the pointer is present in the first area in the first display mode, the object display unit may set the object corresponding to a predetermined position of the first area in a selectable state, and move the plurality of objects in conjunction with an operation of the second input apparatus to change the object in the selectable state. Further, in a case where the input apparatus to be used is switched to the second input apparatus by the input apparatus switching unit when the pointer is present in the second area in the first display mode, the object display unit may determine that an operation for the image having the first resolution displayed in the second area is executed.

As described above, based on the position of the pointer on the screen in the first display mode when the display mode is switched to the second display mode, processing executed by an operation of the second input apparatus may differ, which is effective in the case where the first and second input apparatuses are used in combination or mixed for use, for example.

According to another embodiment, there is provided an information processing method executed by an information processing apparatus as follows.

Specifically, the information processing method includes connecting a first input apparatus and a second input apparatus, the first input apparatus being capable of measuring a movement direction and a movement amount in a two-dimensional space, moving a pointer on a screen corresponding to the two-dimensional space based on a measurement result, and selecting a position on the screen, the second input apparatus being capable of measuring a movement direction and a movement amount in the two-dimensional space, moving a selectable position on the screen corresponding to the two-dimensional space based on a measurement result, and selecting a position on the screen.

An input apparatus to be used is selected by switching between the first input apparatus and the second input apparatus.

A plurality of objects are displayed on the screen and a display mode of the plurality of objects on the screen is selected by switching between a first display mode corresponding to the first input apparatus, and a second display mode corresponding to the second input apparatus, the first display mode being selected when the first input apparatus is used, the second display mode being selected when the second input apparatus is used.

According to another embodiment, there is provided a program causing an information processing apparatus to execute the information processing method described above. The program may be recorded on a recording medium.

As described above, according to the embodiments of the present application, it is possible to efficiently observe an image displayed on a screen irrespective of the type of input apparatus used by a user.

Additional features and advantages are described herein, and will be apparent from the following Detailed Description and the figures.

### BRIEF DESCRIPTION OF THE FIGURES

FIG. 1 is a block diagram showing a structure of an information processing system including at least an information processing apparatus according to a first embodiment;

FIGS. 2a-2b are schematic diagrams showing a mouse and a game controller connected to an input and output interface shown in FIG. 1;

FIG. 3 is a diagram showing an image pyramid structure for explaining the display principle of an image by the information processing apparatus shown in FIG. 1;

FIG. 4 is a diagram for explaining a procedure when an image group of the image pyramid structure shown in FIG. 3 is generated;

FIG. 5 is a block diagram schematically showing a functional structure of a PC as the information processing apparatus according to the first embodiment;

FIG. 6 is a flowchart showing processing performed by an input apparatus switching unit and an object display unit shown in FIG. 5;

FIG. 7 is a schematic diagram showing a pathological image, a plurality of objects, or the like displayed in a mouse mode according to the first embodiment;

FIG. 8 is a diagram for explaining an example of a method of operating a UI (User Interface) in the mouse mode shown in FIG. 7; and

FIG. 9 is a schematic diagram showing a pathological image, a plurality of objects, or the like displayed in a game controller mode according to the first embodiment.

### DETAILED DESCRIPTION

Embodiments of the present application will be described below in detail with reference to the drawings.

### First Embodiment

### Structure of Information Processing Apparatus

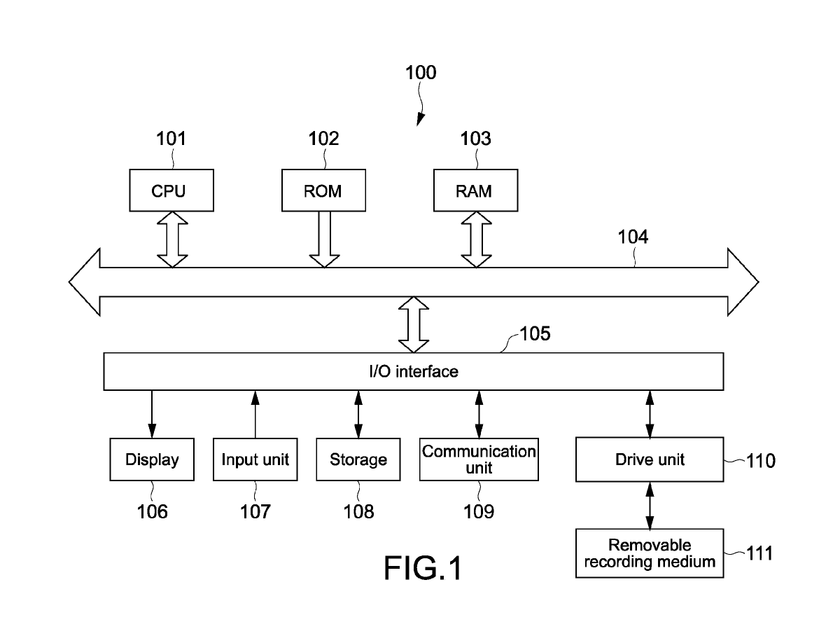

FIG. 1 is a block diagram showing a structure of an information processing system including at least an information processing apparatus according to a first embodiment. As the information processing apparatus, a PC (Personal Computer) 100 is used, for example.

The PC 100 includes a CPU (Central Processing Unit) 101, a ROM (Read Only Memory) 102, a RAM (Random Access Memory) 103, an input and output interface (hereinafter, abbreviated as I/O interface) 105, and a bus 104 that connects those components with one another.

To the I/O interface 105, a display 106, an input unit 107, a storage 108, a communication unit 109, a drive unit 110, and the like are connected. In other words, the I/O interface 105 functions as a connection unit.

The display 106 is a display apparatus using, for example, liquid crystal, EL (Electro-Luminescence), or a CRT (Cathode Ray Tube), and displays an image or an object on a screen based on image data or the like output by the PC 100.

The input unit 107 refers to various input apparatuses such as a pointing device, a keyboard, and a touch panel. In a case where the input unit 107 includes a touch panel, the touch panel may be integrated into the display 106. In this embodiment, to the I/O interface 105, a mouse is connected as a first input apparatus, and a game controller is connected as a second input apparatus. A connection method therefor may be a wired or wireless connection.

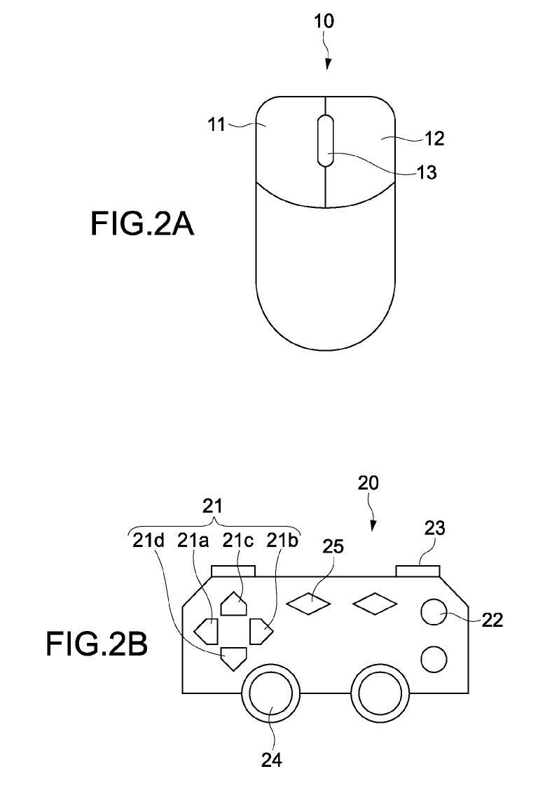

FIG. 2 are schematic diagrams showing the mouse and the game controller. A mouse 10 shown in FIG. 2A is a device capable of controlling the movement of a pointer indicating a position on the screen of the display apparatus, and is placed on a desk or the like and moved by a user in a planar direction.

The mouse 10 has a position sensor (not shown) using a ball, an infrared ray, a laser, or the like therein. With this position sensor, when a user moves the mouse 10, a movement direction and a movement amount in a two-dimensional direction are measured and based on the measurement result, a pointer displayed on the screen is moved. Information for measuring the movement direction and the movement amount may be output to the PC 100 by the mouse 10 so that the movement direction and the movement amount are measured by the PC 100.

Further, the mouse 10 includes a left button 11, a right button 12, and a wheel button 13 roratably provided. The left button 11 and the right button 12 are used for selecting an object displayed on the screen, determining various commands, displaying a menu, or the like. The wheel button 13 is used for enlarging or contracting an image displayed on the screen of the display apparatus, for example. It should be noted that processing executed by operations of the respective buttons, an operation method therefor, or the like may be set as appropriate. Further, buttons or the like other than those described above may be provided to the mouse 10.

By using the mouse 10, a user can move the pointer displayed on the screen to select a predetermined position on the screen.

The game controller 20 shown in FIG. 2B includes an arrow key 21 having left, right, up, and down buttons 21a to 21d, a determination button 22, an LR button 23, a stick 24, and a start button 25. When a user presses the arrow key 21, a movement direction and a movement amount with respect to a two-dimensional space are measured based on a pressed position of the arrow key 21 (left, right, up, and down buttons 21a to 21d), a pressing force, a period of time of the press, or the like. Alternatively, information for measuring the movement direction and the movement amount may be output to the PC 100 so that the movement direction and the movement amount are measured by the PC 100.

In this embodiment, based on the measurement result described above, a selectable position is moved. The selectable position is a position at which an object or the like positioned on the screen can be selected. An object or the like at the selectable position is displayed in focus or displayed while being surrounded by a frame.

The stick 24 is used by a user while being inclined in a desired direction of all directions of 360°. Based on the direction or angle inclined by the user, or the like, a movement direction and a movement amount are measured. Alternatively, the information for the measurement is output to the PC 100.

The determination button 22 is used for determining a selection of an object or the like, or determining an execution of various types of commands, for example. The LR button 23 is used for enlarging or contracting an image displayed on the screen. The start button 25 is used for starting various types of menus, for example. It should be noted that roles, positions, or the like of the respective buttons may be set as appropriate.

The storage 108 shown in FIG. 1 is a non-volatile storage device such as an HDD (Hard Disk Drive), a flash memory, and another solid-state memory.

The drive unit 110 is a device capable of driving a removable recording medium 111 such as an optical recording medium, a floppy (registered trademark) disk, a magnetic recording tape, and a flash memory. In contrast, the storage 108 is often used as a device that is previously included in the PC 100 and mainly drives a recording medium that is not removable.

The communication unit 109 is a modem, a router, or another communication device that is connectable to a LAN (Local Area Network), a WAN (Wide Area Network), or the like and is used for communicating with another device. The communication unit 109 may perform one of a wired communication or a wireless communication. The communication unit 109 is used separately from the PC 100 in many cases.

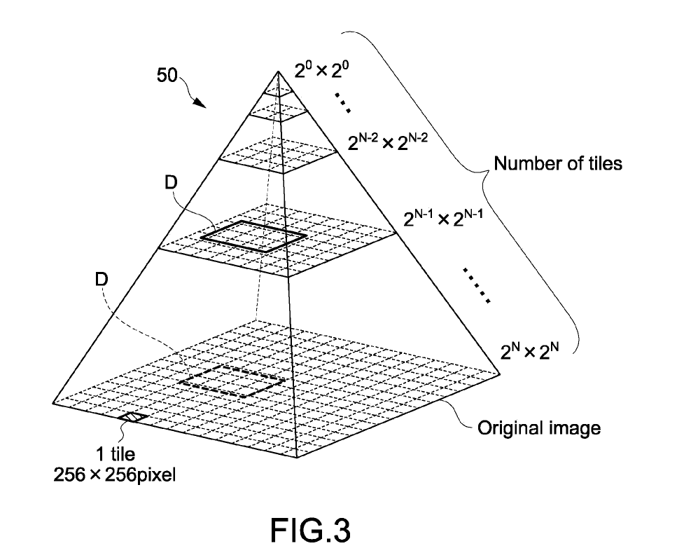

Next, an image displayed on the screen of the display apparatus connected to the PC 100 according to this embodiment will be described. In this embodiment, an image obtained by an optical microscope (hereinafter, referred to as pathological image) is stored in the storage 108 of the PC 100, and the pathological image is displayed on the screen of the display apparatus. FIG. 3 is a diagram showing an image pyramid structure for explaining the display principle thereof.

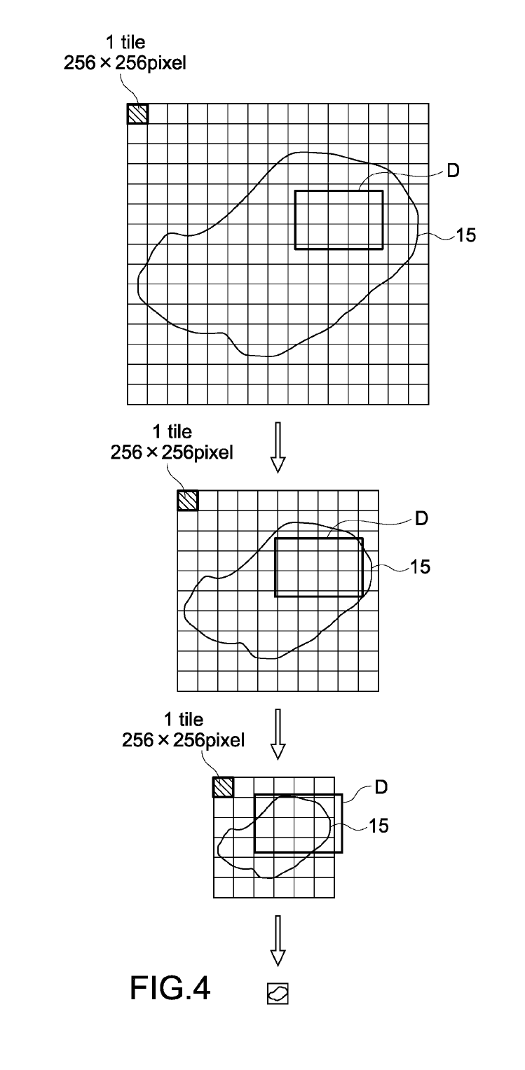

An image pyramid structure 50 in this embodiment is an image group (whole image group) generated for the same image obtained from a single observation target 15 (see FIG. 4) by an optical microscope in different resolutions. In the lowermost layer of the image pyramid structure 50, an image having the largest size is arranged, and in the uppermost layer thereof, an image having the smallest size is arranged. The resolution of the image having the largest size is, for example, 40×30 (Kpixels) or 50×50 (Kpixels). The resolution of the image having the smallest size is, for example, 256×256 (pixels) or 256×512 (pixels).

Specifically, when those images are each displayed on the same display 106 at 100%, for example (displayed at the number of dots which is physically the same as the number of pixels of each image), the image having the largest size is displayed largest and the image having the smallest size is displayed smallest. Here, in FIG. 3, a display range of the display 106 is denoted by D.

FIG. 4 is a diagram for explaining a procedure when an image group of the image pyramid structure 50 is generated.

First, a digital image of the original image obtained by an optical microscope (not shown) at a predetermined observation magnification is prepared. This original image corresponds to the image having the largest size, which is the lowermost image of the image pyramid structure 50 shown in FIG. 3. In other words, the original image is an image having the highest resolution. Therefore, as the lowermost image of the image pyramid structure 50, an image that is observed at a relatively high magnification and then obtained by the optical microscope is used.

It should be noted that in the field of pathology, generally, a matter obtained by slicing an organ, a tissue, or a cell of a living body, or a part thereof is an observation target 15. Then, a scanner apparatus (not shown) having a function of an optical microscope reads out the observation target 15 set on a glass slide, to thereby store a digital image thus obtained in the scanner apparatus or another storage apparatus.

As shown in FIG. 4, the scanner apparatus or a general-purpose computer (not shown) generates a plurality of images having resolutions reduced stepwise, from the image having the largest size obtained as described above. Then, the scanner apparatus or the general-purpose computer stores those images in units of “tiles” of a predetermined size, for example. The size of one tile is, for example, 256×256 (pixels). The image group thus generated forms the image pyramid structure 50, and the image pyramid structure 50 is stored in the storage 108 of the PC 100. In reality, the PC 100 may only have to store those images having different resolutions and resolution information items in association with each other. It should be noted that the PC 100 shown in FIG. 1 may generate and store the image pyramid structure 50.

The whole image group forming the image pyramid structure 50 may be generated by a known compression method, or generated by a known compression method used when a thumbnail image is generated, for example.

The PC 100 uses software that adopts a system of the image pyramid structure 50, to extract a desired image from the image pyramid structure 50 in accordance with an input operation made by a user via the input unit 107 and then output the image to the display 106. Specifically, the PC 100 displays an image of any part selected by the user from an image having any resolution selected by the user. By such processing, the user can obtain a feeling of observing an observation target 15 while changing an observation magnification. In other words, the PC 100 functions as a virtual microscope. The virtual observation magnification used here corresponds to the resolution in actuality.

Operation of Information Processing Apparatus

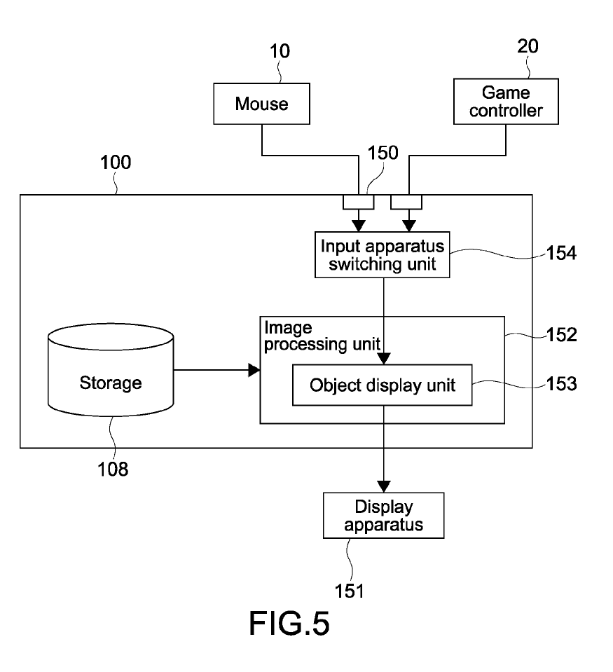

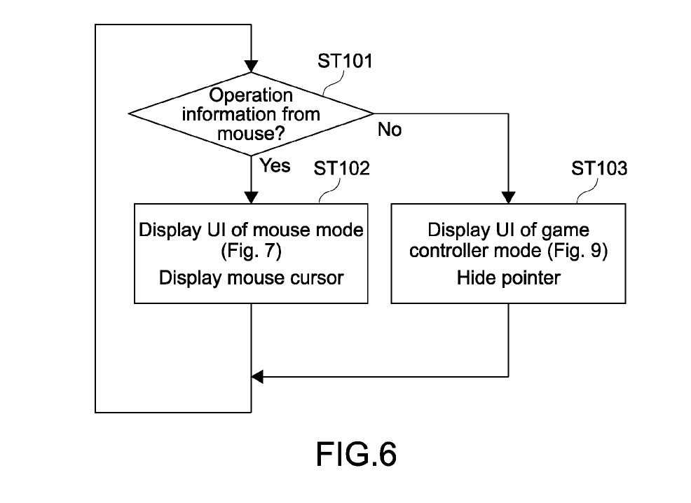

FIG. 5 is a block diagram schematically showing a functional structure example of the PC 100 as the information processing apparatus according to this embodiment. FIG. 6 is a flowchart showing processing performed by an input apparatus switching unit and an object display unit shown in FIG. 5. The processing of each processing unit shown in FIG. 5 is realized in cooperation with software stored in the storage 108, the ROM 102, or the like and hardware resources of the PC 100. Specifically, the CPU 101 loads a program constituting the software, which is stored in the storage 108, the ROM 102, or the like, to the RAM 103 and then executes the program, thus realizing the processing of each processing unit.

Operation information for operating a pathological image or a UI (User Interface) displayed on the screen of the display apparatus 151 is output with any one of the mouse 10 and the game controller 20 connected to the connection unit 150 (I/O interface 105). It is judged by an input apparatus switching unit 154 whether the output operation information is operation information output by operating the mouse 10 (Step 101 in FIG. 6). In other words, whether the operation information to be used by the PC 100 is operation information output from the mouse 10 or operation information output from the game controller 20 is judged. Information of a result judged by the input apparatus switching unit 154 is output to the object display unit 153 included in an image processing unit 152.

In a case where it is judged by the input apparatus switching unit 154 that the output operation information is operation information output from the mouse 10, and information of the judgment result is output to the object display unit 153 (Yes in Step 101), the object display unit 153 sets a mouse mode that is a first display mode. Then, the object display unit 153 displays a mouse cursor as a pointer, a plurality of objects, or the like on the screen in the mouse mode (Step 102). In other words, an UI of the mouse mode is displayed on the screen.

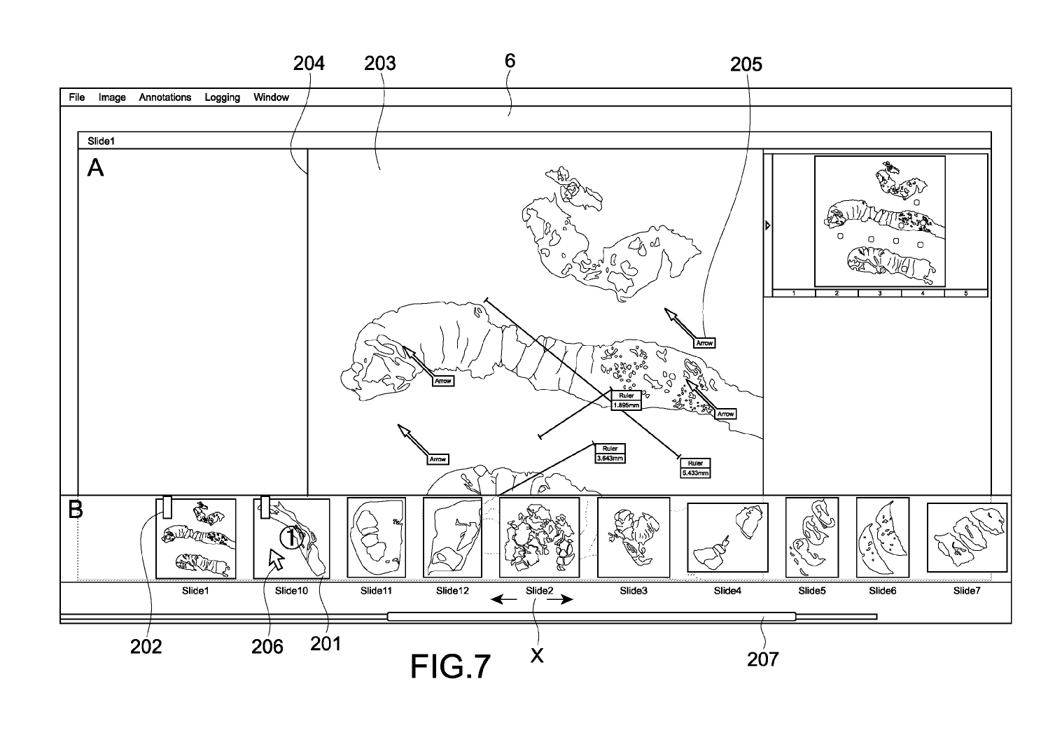

FIG. 7 is a schematic diagram showing a pathological image, a plurality of objects, or the like displayed in the mouse mode according to this embodiment. Here, as a plurality of objects 201, at least one whole image of whole images other than the original image in the whole image group of the image pyramid structure 50 described with reference to FIG. 4 is used as a thumbnail image. Hereinafter, the object 201 will be described as a thumbnail image 201.

As shown in FIG. 7, the PC according to this embodiment sets an area B serving as a first area and an area A serving as a second area on a screen 6. In the area B, a plurality of thumbnail images 201 are arranged. In the arranged thumbnail images 201, thumbnail images 201 of Slide 1 and Slide 10 are each provided with a tag 202 indicating a thumbnail image 201 to be focused by a user.

Displayed in the area A is a pathological image 203 corresponding to a thumbnail image 201 selected by a user via the mouse 10 from the plurality of thumbnail images 201 arranged in the area B. As shown in FIG. 7, the area A has a display area 204, and an image of the display range D shown in FIG. 3 is displayed in the display area 204. An annotation 205 indicating a user's comment or the like is set by the user at a predetermined position of the pathological image 203.

It should be noted that the area B on the screen 6 may be displayed only when necessary. In other words, for example, when a pathological image 203 displayed in the area A is observed by the user, it may be possible to hide the area B and observe the pathological image 203 on the entire screen 6.

Here, an example of an operation method for a UI in the mouse mode shown in FIG. 7 will be displayed.

In the case where the user wants to display one of the thumbnail images 201 arranged in the area B in the display area 204 of the area A, the user operates the mouse 10 to move a mouse cursor 206 on a thumbnail image 201 to be displayed. Then, the user double-clicks the thumbnail image 201 with the left button 11 of the mouse 10 (see FIG. 2). Accordingly, the selected thumbnail image 201 is displayed in the display area 204 of the area A. In the case where the user wants to display another thumbnail image 201 in the display area 204, the user only has to move the mouse cursor 206 and change a selectable thumbnail image 201.

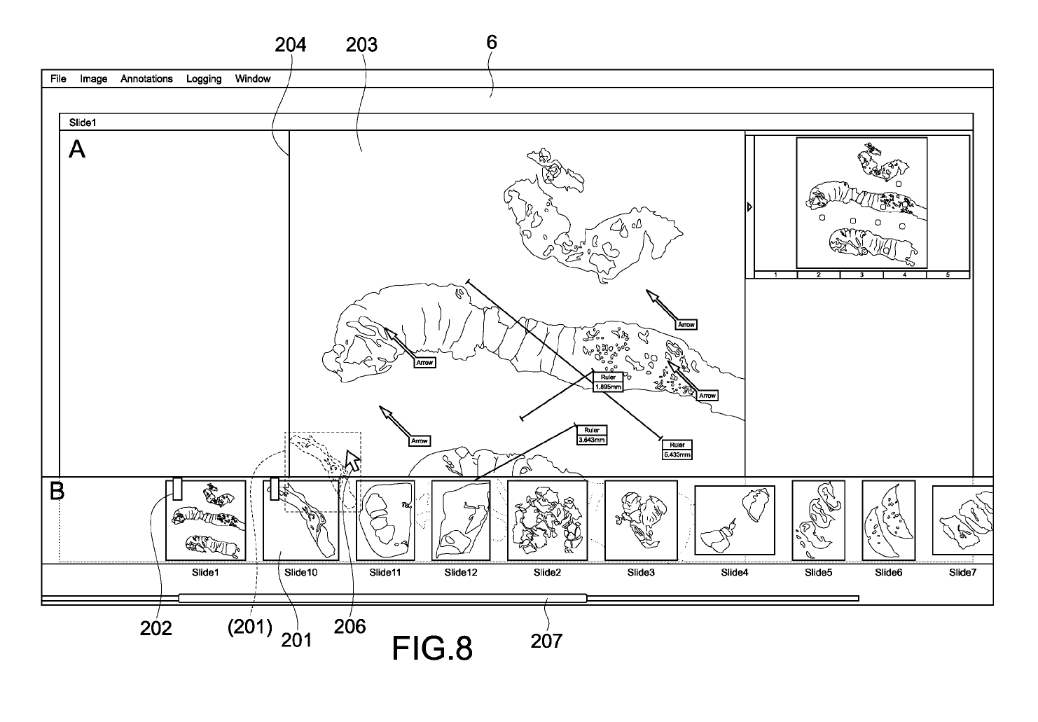

Alternatively, as shown in FIG. 8, it may be possible to move the mouse cursor 206 to a thumbnail image 201 to be displayed in the display area 204 and then perform a drag operation with the mouse 10. After that, a drop operation is performed in the area A, which means that the thumbnail image 201 concerned is selected as an image to be displayed in the display area 204, and the thumbnail image 201 is displayed in the display area 204.

In the case where display positions of the thumbnail images 201 arranged in the area B are intended to be moved, the mouse cursor 206 is moved onto a scroll bar 207 shown in FIG. 7 and FIG. 8, and the mouse 10 is moved to right and left while the left button 11 is being pressed. With this operation, the scroll bar 207 is moved to right and left and along with this movement, the display positions of the thumbnail images 201 arranged in the area B are moved to right and left. Alternatively, the mouse cursor 206 is moved to an area X between the arranged thumbnail images 201 and the scroll bar 207, and the mouse 10 is moved to right and left while the left button 11 is being pressed. With this operation, the display positions of the thumbnail images 201 arranged in the area B are moved to right and left. The thumbnail images 201 whose display positions are moved may be stopped at any position of the area B based on the movement amount measured by the mouse 10.

In the area A, after the mouse cursor 206 is moved on the pathological image 203 displayed in the display area 204, the mouse 10 is moved in any direction in the state where the left button 11 is being pressed. Accordingly, the execution of an operation of moving the pathological image 203 is determined. As a result, the position of the display range D shown in FIG. 3 is moved, and the pathological image 203 displayed in the display area 204 by the image processing unit 152 is moved at the same time.

As described above, in the UI of the mouse mode serving as the first display mode, an optimum UI for the operations of the mouse 10, such as an operation of moving the mouse cursor 206 to select a predetermined position on the screen 6, drag and drop operations, and the like, is displayed on the screen 6. Accordingly, the user can efficiently observe the pathological image 203 with use of the mouse 10. However, an operation method for the UI in the mouse mode is not limited to the method described above.

In Step 101 of FIG. 6, in the case where it is judged by the input apparatus switching unit 154 that the output operation information is not operation information output from the mouse 10, and information of the judgment result is output to the object display unit 153 (No of Step 101), the object display unit 153 sets a game controller mode serving as a second display mode. Then, the object display unit 153 displays a plurality of objects or the like on the screen 6 in the game controller mode (Step 103). In other words, a UI of the game controller mode is displayed on the screen 6. It should be noted that in the game controller mode according to this embodiment, a pointer indicating a position on the screen 6 is not displayed.

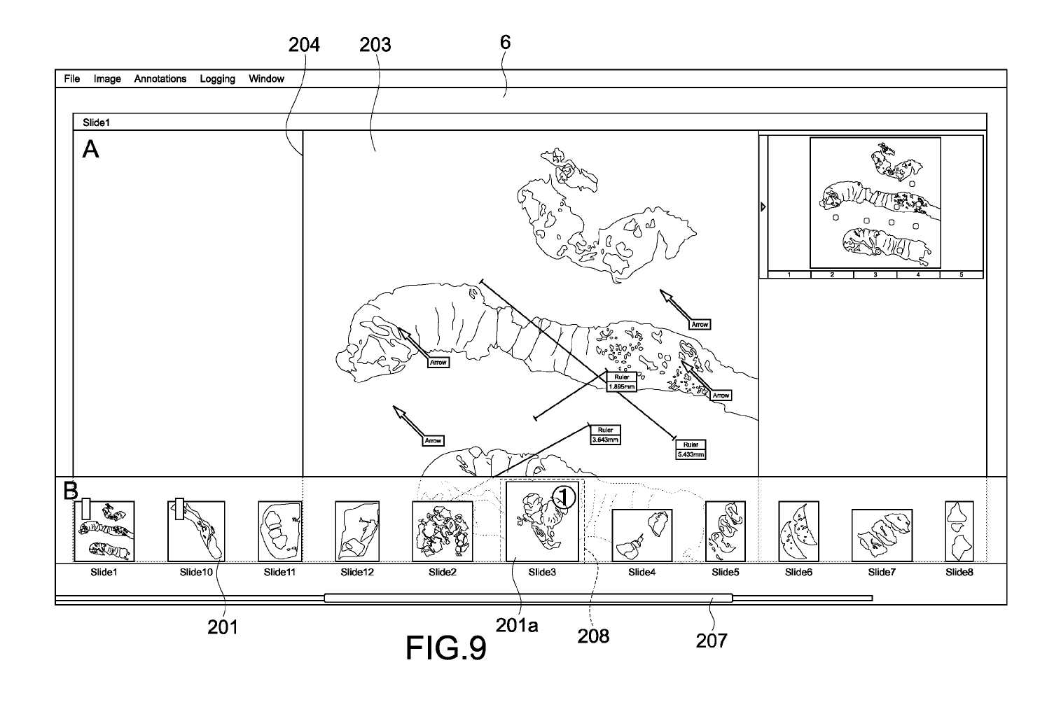

FIG. 9 is a schematic diagram showing a pathological image 203, a plurality of thumbnail images 201, or the like displayed in the game controller mode according to this embodiment. As shown in FIG. 9, also in the game controller mode, the area A including the display area 204 in which the pathological image 203 is displayed, and the area B in which the plurality of thumbnail images 201 are arranged are set on the screen 6. The pathological image 203 displayed in the display area 204 of the area A is an image corresponding to a thumbnail image 201 selected by a user via the mouse 10.

In the area B shown in FIG. 9, a thumbnail image 201a (Slide 3) positioned at the center of the arranged thumbnail images 201 is displayed so as to be larger than the other thumbnail images 201. This means that the thumbnail image 201a positioned at the center of the area B is in a selectable state. In this embodiment, a frame 208 is attached to the thumbnail image 201a in the selectable state, with the result that the thumbnail image 201a is displayed with emphasis.

An example of an operation method for a UI with use of the game controller shown in FIG. 9 will be described.

In the case where a user wants to display one of the thumbnail images 201 arranged in the area B in the display area 204 of the area A, the user operates the left and right buttons 21a and 21b of the arrow key 21 of the game controller 20. With this operation, a thumbnail image 201a that is positioned at the center of the screen and is in a selectable state is selected as appropriate. For example, in the case where the user wants to make a thumbnail image 201 of Slide 11 selectable in the state shown in FIG. 9, the user presses the right button 21b of the arrow key 21 three times. Then, the display position of the plurality of thumbnail images 201 is moved to the right stepwise, and the thumbnail image 201 of Slide 11 is positioned at the center of the area B and becomes selectable. The user presses the determination button 22 of the game controller 20 in that state, and thus a pathological image 203 corresponding to the thumbnail image 201 of Slide 11 is displayed in the display area 204. As described above, the thumbnail image 201a positioned at the center of the area B in the selectable state is displayed with emphasis. Accordingly, the user can efficiently perform a selection operation of the thumbnail image 201a in the area B.

In the area A, the user presses any of the left, right, up, and down buttons 21a to 21d of the arrow key 21, with the result that the execution of an operation of moving the pathological image 203 is determined. As a result, the position of the display range D shown in FIG. 3 is moved and the pathological image 203 displayed in the display area 204 is moved by the image processing unit 152 at the same time. In this embodiment, the display range D is moved so that the position before the movement and that after the movement are adjacent to each other. The adjacent direction is determined in accordance with the left, right, up, and down buttons 21a to 21d of the arrow key 21 pressed by the user. Accordingly, in the display area 204 of the area A, a pathological image 203 of an area adjacent to the pathological image 203 that has been displayed before the movement is displayed.

As described above, in the UI of the game controller mode serving as the second display mode, an optimum UI for the operation of the game controller 20, such as selection of a thumbnail image 201 on the screen 6 by operating the arrow key 21, is displayed on the screen 6. Accordingly, the user can efficiently observe the pathological image 203 with use of the game controller 20. However, an operation method for the UI in the game controller mode is not limited to the method described above.

As described above, in the PC 100 as the information processing apparatus according to this embodiment, the mouse 10 and the game controller 20 are connected to the connection unit 150 as different types of input apparatuses. Then, the display modes of the thumbnail images 201 or the like displayed on the screen 6 are switched between when the PC 100 uses the operation information output from the mouse 10 and when the PC 100 uses the operation information output from the game controller 20. In other words, the UIs displayed on the screen 6 are switched between when the user uses the mouse 10 and when the user uses the game controller 20. Accordingly, the user can efficiently observe the pathological image 203 displayed on the screen 6 irrespective of whether an input apparatus to be used is the mouse 10 or the game controller 20.

As described above, in the mouse mode set in the case where the user uses the mouse 10, an optimum UI for an operation of the mouse 10 is displayed on the screen 6. On the other hand, in the game controller mode set in the case where the user uses the game controller 20, an optimum UI for an operation of the game controller 20 is displayed on the screen 6. Accordingly, for example, in the case where the user uses the mouse 10 and the game controller 20 in combination, the user can observe a pathological image 203 in a display mode that is easy for the user to operate by selecting the mouse 10 or the game controller 20 as appropriate. For example, when the pathological image 203 is intended to be moved by a desired distance frequently, an operation is easier to be made in the mouse mode. When the entire pathological image 203 is intended to be observed sequentially for each area, an operation is easier to be made in the game controller mode.

Further, in the field of medicine or the like, there are many cases where a plurality of pathologists share one monitor screen and diagnose or verify one pathological image 203 while discussing the pathological image 203. In the case where the diagnosis or the like of such a form called conference is performed, there is conceived a case where the mouse 10 and the game controller 20 are mixed as input apparatuses to be used by the respective pathologists. Even in such a case, UIs on the screen 6 can be switched as appropriate in the PC 100 according to this embodiment, with the result that the plurality of users can efficiently observe a pathological image 203.

### Second Embodiment

A PC as an information processing apparatus according to a second embodiment will be described. In the following description, the structures and actions similar to those of the PC 100 described in the first embodiment will not be described or simply described.

A PC according to this embodiment operates as follows when an object display unit switches from a mouse mode to a game controller mode.

It is assumed that when a mouse cursor 206 is present in the area B shown in FIG. 7 described above, operation information is output from a game controller. Then, a judgment result indicating that the operation information is information output from the game controller is output by an input apparatus switching unit to the object display unit, and a UI of the game controller mode is displayed on the screen 6 shown in FIG. 9. At this time, the object display unit switches between UIs on the screen 6 in a state where the display positions of the respective thumbnail images 201 arranged in the area B can be moved by the arrow key. As a selectable thumbnail image 201a positioned at the center of the area B in the game controller mode, a thumbnail image 201 displayed at a position closest to the center of the area B in the mouse mode shown in FIG. 7 may be set.

For example, in the case where UIs on the screen 6 are switched by the user pressing the left and right buttons of the arrow key of the game controller, a thumbnail image 201a in a selectable state positioned at the center of the area B may be changed simultaneously with the switching between UIs. In other words, it may be possible to switch between UIs in conjunction with the operations of the left and right buttons and simultaneously move the display positions of the respective thumbnail images 201 arranged in the area B. Accordingly, the switching from the mouse mode to the game controller mode is performed smoothly.

On the other hand, it is assumed that when the mouse cursor 206 is present in the area A shown in FIG. 7 described above, operation information is output from the game controller. In this case, the object display unit switches between UIs on the screen 6 in a state where the pathological image 203 displayed on the area A can be moved by the arrow key. Also for the switching between UIs, it may be possible to switch between UIs in conjunction with the operations of the arrow key and simultaneously move the pathological image 203 displayed in the area A. Accordingly, the switching from the mouse mode to the game controller mode is performed smoothly.

As described above, the processing executed by an operation of the game controller may differ depending on the display position of the mouse cursor 206 in the mouse mode. Further, a display mode switching method from the mouse mode to the game controller mode may be set as appropriate. Accordingly, in a case where a mouse and a game controller are used in combination or mixed for use, an observation target can be observed by a user without being conscious of switching between display modes.

### Other Embodiments

Embodiments according to the present application are not limited to the embodiments described above, and various embodiments are possible.

For example, it may be possible to set the following authority for a predetermined input apparatus of a plurality of input apparatuses connected to a connection unit of a PC. Specifically, it is assumed that an input apparatus having the authority operates a UI of a display mode corresponding to the input apparatus. In this case, even when operation information is output from different kinds of input apparatuses, an object display unit does not execute switching between UIs on the screen. In the case where operation information that permits switching between UIs is output from the input apparatus having the authority, the object display unit executes the switching between UIs. Alternatively, in the case where predetermined operation information is output from different kinds of input apparatuses, the object display unit executes the switching between UIs. In this manner, it may be possible to set the authority for a predetermined input apparatus, and set a limit on the switching between UIs on the screen based on the operation information output from another input apparatus.

Further, it is assumed that when a UI in the mouse mode is displayed on the screen, a user operates the stick 24 of the game controller (see FIG. 2). In this case, the object display unit may not execute the switching between UIs on the screen, and a UI in the mouse mode may be continuously displayed.

In the UI of the game controller mode shown in FIG. 9, a pointer is not displayed on the screen 6. However, if it is assumed the case where a pointer is operated by the game controller, a pointer may be displayed on the screen 6 as a UI of the game controller.

In the embodiments described above, there has been described the case where the plurality of input apparatuses and the display apparatus having the screen are connected to the I/O interface 105 of the PC 100 described with reference to FIG. 1. However, as the information processing apparatus according to each embodiment, a PC or the like integrally provided with a plurality of display apparatuses and screens may be used.

Although the PC is used as the information processing apparatus according to the above embodiments, the information processing apparatus is not limited to the PC and a dedicated information processing apparatus may be used. Further, as the information processing apparatus, though not limited to apparatuses realizing the above information processing in cooperation with hardware resources and software, the above information processing may be realized by dedicated hardware.

The information processing apparatus according to each embodiment described above is used without being limited to the field of medicine, pathology, or the like, and is applicable to other fields.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. An information processing apparatus, comprising:
a connection unit configured to connect a first input apparatus and a second input apparatus, the first input apparatus being capable of measuring a movement direction and a movement amount in a two-dimensional space, moving a pointer on a screen corresponding to the two-dimensional space based on a measurement result, and selecting a position on the screen, the second input apparatus being capable of measuring a movement direction and a movement amount in the two-dimensional space, moving a selectable position on the screen corresponding to the two-dimensional space based on a measurement result, and selecting a position on the screen;
an input apparatus switching unit configured to select an input apparatus to be used by switching between the first input apparatus and the second input apparatus; and
an object display unit configured to display a plurality of objects on the screen and select a display mode of the plurality of objects on the screen by switching between a first display mode corresponding to the first input apparatus and a second display mode corresponding to the second input apparatus, the first display mode being selected when the first input apparatus is used, the second display mode being selected when the second input apparatus is used.

2. The information processing apparatus according to claim 1, wherein
when the first input apparatus is used, the object display unit arranges the plurality of objects on the screen, sets one of the plurality of objects displayed in a selectable state, and sets, as the first display mode, a display mode in which the object in the selectable state is changed by moving the pointer in conjunction with an operation of the first input apparatus, and
when the second input apparatus is used, the object display unit arranges the plurality of objects on the screen, sets one of the plurality of objects, which corresponds to a predetermined position on the screen, in a selectable state, and sets, as the second display mode, a display mode in which the object in the selectable state is changed by moving the plurality of objects in conjunction with an operation of the second input apparatus.

3. The information processing apparatus according to claim 2, wherein
the second display mode is a display mode in which the object set in the selectable state is displayed with emphasis.

4. The information processing apparatus according to claim 1, further comprising a storage configured to store a plurality of image data items each having a first resolution, wherein
each of the plurality of objects is an image obtained by drawing one of the plurality of image data items stored in the storage in a second resolution smaller than the first resolution.

5. The information processing apparatus according to claim 4, wherein
the object display unit sets a first area and a second area on the screen, displays a plurality of images each having the second resolution in the first area, as the plurality of objects, and displays, in the second area, an image having the first resolution that corresponds to one of the plurality of objects selected in the first area by one of the first input apparatus and the second input apparatus,
in a case where the input apparatus to be used is switched to the second input apparatus by the input apparatus switching unit when the pointer is present in the first area in the first display mode, the object display unit sets the object corresponding to a predetermined position of the first area in a selectable state, and moves the plurality of objects in conjunction with an operation of the second input apparatus to change the object in the selectable state, and
in a case where the input apparatus to be used is switched to the second input apparatus by the input apparatus switching unit when the pointer is present in the second area in the first display mode, the object display unit determines that an operation for the image having the first resolution displayed in the second area is executed.

6. An information processing method executed by an information processing apparatus, the method comprising:
connecting a first input apparatus and a second input apparatus, the first input apparatus being capable of measuring a movement direction and a movement amount in a two-dimensional space, moving a pointer on a screen corresponding to the two-dimensional space based on a measurement result, and selecting a position on the screen, the second input apparatus being capable of measuring a movement direction and a movement amount in the two-dimensional space, moving a selectable position on the screen corresponding to the two-dimensional space based on a measurement result, and selecting a position on the screen;
selecting an input apparatus to be used by switching between the first input apparatus and the second input apparatus; and
displaying a plurality of objects on the screen and selecting a display mode of the plurality of objects on the screen by switching between a first display mode corresponding to the first input apparatus and a second display mode corresponding to the second input apparatus, the first display mode being selected when the first input apparatus is used, the second display mode being selected when the second input apparatus is used.

7. A program causing an information processing apparatus to execute:
connecting a first input apparatus and a second input apparatus, the first input apparatus being capable of measuring a movement direction and a movement amount in a two-dimensional space, moving a pointer on a screen corresponding to the two-dimensional space based on a measurement result, and selecting a position on the screen, the second input apparatus being capable of measuring a movement direction and a movement amount in the two-dimensional space, moving a selectable position on the screen corresponding to the two-dimensional space based on a measurement result, and selecting a position on the screen;
selecting an input apparatus to be used by switching between the first input apparatus and the second input apparatus; and
displaying a plurality of objects on the screen and selecting a display mode of the plurality of objects on the screen by switching between a first display mode corresponding to the first input apparatus and a second display mode corresponding to the second input apparatus, the first display mode being selected when the first input apparatus is used, the second display mode being selected when the second input apparatus is used.
